(19) United States
(12) Patent Application Publication
(10) Pub. No.: US 2013/0302161 A1
(43) Pub. Date: Nov. 14, 2013

(54) CONTROLLER OF WIND TURBINE AND WIND TURBINE

(71) Applicants: Arne Koerber, Berlin (DE); Charudatta Subhash Mehendale, Niskayuna, NY (US)

(72) Inventors: Arne Koerber, Berlin (DE); Charudatta Subhash Mehendale, Niskayuna, NY (US)

(21) Appl. No.: 13/466,194

(22) Filed: May 8, 2012

(51) Int. Cl. F03D 7/04

(52) U.S. Cl. 416/1; 416/9

(57) ABSTRACT

Techniques for operating a wind turbine are described herein. In an example, a wind turbine includes a tower, a nacelle coupled to the tower, a rotor rotatably coupled to the nacelle, at least one blade coupled to the rotor and configured to rotate about a pitch axis, and a controller to operate the wind turbine based on predicted wind speed values. The controller includes a twist determination module to determine a blade-twist value, wherein the blade-twist value is indicative of an actual blade-twist of a rotor blade during operation of the wind turbine. The controller may further include a wind speed determination module to determine at least one wind speed value indicative of a wind speed using the blade-twist value.

### BACKGROUND OF THE INVENTION

The subject matter described herein relates generally to methods and systems for operating a wind turbine.

Wind turbines may include a tower and a nacelle mounted on the tower. A rotor is rotatably mounted to the nacelle and is coupled to a generator by a shaft. A plurality of blades extends from the rotor. The blades are oriented such that wind passing over the blades turns the rotor and rotates the shaft, thereby driving the generator to generate electricity.

Some types of wind turbine, referred to as variable wind speed turbines, generate power at different wind speeds. During control of variable speed wind turbines, operating points at each wind speed may be selected in order to conveniently generate power without over-stressing components of the wind turbine. To implement such control strategies, knowledge of the wind flow is central and, in particular, of the wind speed impinging on the wind turbine rotor. Therefore, a wind turbine system may track wind flow over time for improving control.

One approach for wind tracking is to provide a wind turbine with wind sensors such as an anemometer installed near to the area swept by rotor blades. However, such a wind sensor only measures wind flow at a limited number of points. Further, rotating blades may alter the wind flow thereby altering the measurements of a wind sensor. Other approaches estimate wind flow by evaluating other operating parameters of the wind turbine such as rotor speed, electrical output power or tower deflection. However, under certain circumstances such estimates might not be sufficiently accurate.

### BRIEF DESCRIPTION OF THE INVENTION

In one aspect, a controller for a wind turbine is described. The wind turbine includes at least one rotor blade. The controller includes a determination module to determine a blade-twist value. The blade-twist value is indicative of an actual blade-twist of a rotor blade during operation of the wind turbine. According to at least some embodiments, the controller further includes a wind speed determination module to determine at least one wind speed value indicative of a wind speed using the blade-twist value.

In another aspect, a wind turbine includes a tower, a nacelle coupled to the tower, a rotor rotatably coupled to the nacelle; a blade coupled to the rotor and configured to rotate about a pitch axis; and, a controller to operate the wind turbine based on predicted wind speed values. The controller includes a determination module to predict wind speed values by estimating a blade-twist value indicative of an actual blade-twist of a rotor blade.

In yet another aspect, a method of operating a wind turbine is provided. The wind turbine includes a rotatable rotor, and b) at least one blade coupled to the rotor. The at least one blade is configured to rotate about a pitch axis. The method includes determining, during operation of the wind turbine, a wind speed based on an actual blade-twist of a rotor blade during operation of the wind turbine. The method further includes controlling operation of the wind turbine using the determined wind speed.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1.

FIG. 3 is a perspective view of a rotor blade of the wind turbine shown in FIG. 1.

FIG. 4 is another perspective view illustrating the rotor blade as seen from the root of the rotor blade.

FIG. 5 is a block diagram of a control system of the wind turbine shown in FIG. 1.

FIG. 6 is a block diagram schematically illustrating determination of wind speed values in the control system of FIG. 5.

FIG. 7 is a diagram depicting a process for operation of the wind turbine of FIG. 1.

FIG. 8 is a block diagram of an alternative control system of the wind turbine shown in FIG. 1.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

In some embodiments herein, a wind turbine system is described that determines a value of a blade-twist value indicative of an actual blade-twist of a rotor blade during operation of the wind turbine. Depending on the particular wind turbine system, a blade-twist value as referred herein may correspond to a variety of wind turbine parameters that are indicative of blade-twist. For example, as further set forth below, such a blade-twist value may correspond to raw sensor signals that provide a measurement corresponding to blade-twist; further, such a blade-twist value may correspond to processed raw sensor signals; further, such a blade-twist value may correspond to estimated values.

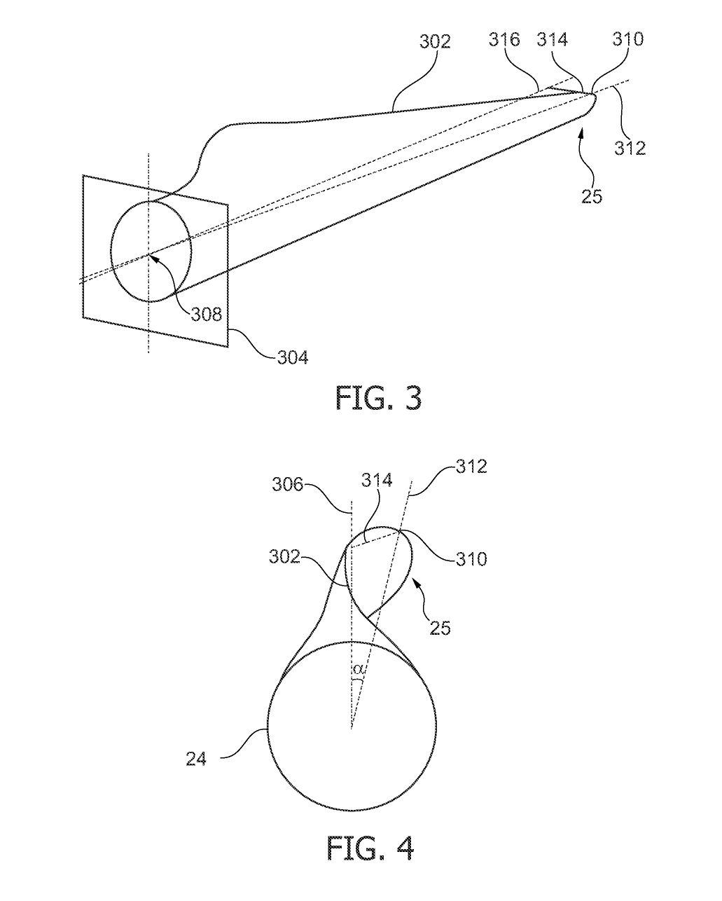

A blade-twist corresponds to the twist angle at any radial location of a rotor blade. The twist angle refers to the difference in perspective angle relative to, e.g., the rotor axis between two sections of the rotor blade along the longitudinal axis of the blade. A twist angle may refer particularly to an angle difference between a root section and a radially spaced blade section. An example of a blade-twist value is the root-to-tip twist illustrated below with respect to FIGS. 3A-3B. Blade-twist variations correspond to physical deformations of blade sections as, for example, caused by loads acting on the wind turbine.

According to some examples, blade-twist values may be determined based upon sensor measurements for measuring blade-twist. For example, but not limited thereto, such sensor measurements may be provided by a surveying system arranged to optically measure blade-twist values or a strain gauge arrangement arranged to measure blade torque. Alternatively, or in addition thereto, blade-twist values may be determined based on a blade-twist estimation. Such a blade-twist estimation may be inferred using a system model. For example, blade-twist estimation may be obtained using an extended Kalman filter as described herein.

Blade-twist determination facilitates a more convenient control of a wind turbine. More specifically, control of a wind turbine may take into account the aerodynamic characteristics of a wind turbine rotor. However, such aerodynamic characteristics may vary with a deformation of the blades shape and, more particularly, with changes in blade-twist angle. Changes in blade-twist angle may be particularly prominent in aeroelastic tailored blades which are specifically designed to change their aerodynamic behavior in response to blade loading. Blade-twist determination as described herein facilitates taking into account blade deformation arising during operation of the wind turbine, thereby facilitating a reliable control of a wind turbine.

Further, blade-twist determination may also be used to monitor the condition of rotor blades. For example, blade-twist determination may be used to monitor whether twist is abnormal. Twist values above the stored expected values may be indicative of an excessive loading. More specifically, twist values determined as described herein may be compared with stored expected values. If blades are twisted during operation beyond a threshold level that may, at least potentially, induce structural damages in a rotor blade, then twist may be considered abnormally high. Such a threshold level may be reached when actual twist values are higher than stored expected values. A twist threshold level may correspond to a pre-determined value. Alternatively, a twist threshold level may be dynamically selected during operation of a wind turbine. For example, a twist threshold level may be dynamically selected based on other parameters of the wind turbine such as, but not limited to, wind speed, pitch angle or power output. If an abnormally high twist is detected, it may trigger a signal indicating that blade inspection or replacement is advisable. Twist values below the stored expected values may be indicative of other types of problems, such as blade stalling or ice formation on the blade.

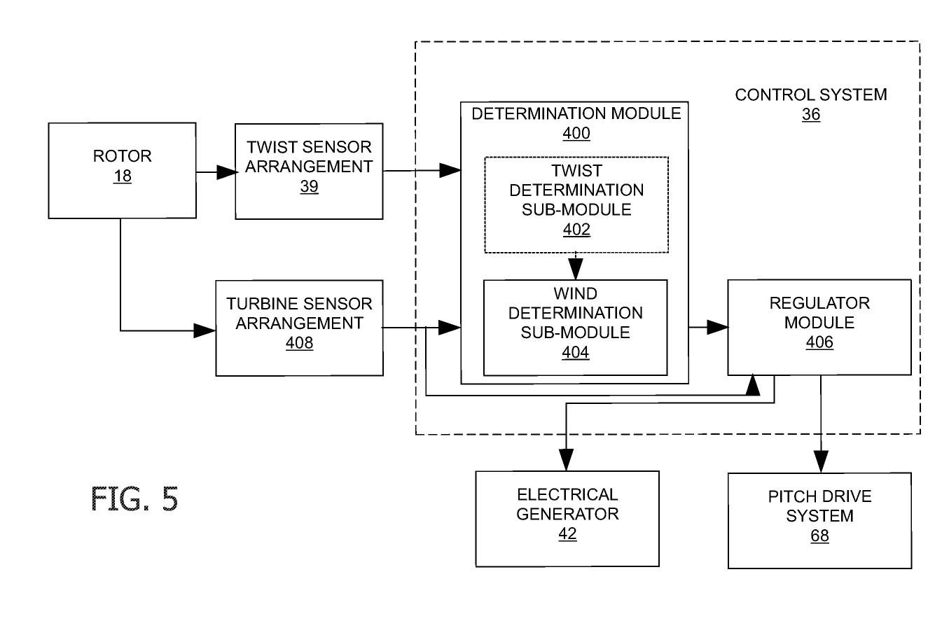

In at least some embodiments herein, a controller may be configured to determine wind speed or, at least, a value of a parameter indicative of wind speed. Thereby, an accurate estimation of the effective wind speed at the wind turbine rotor may be obtained even when blades aerodynamic characteristics change during operation of a wind turbine. Such accurate estimate may be valid even for blades prone to significant changes in their aerodynamic characteristics, as the case may be for aeroelastic tailored blades. Moreover, predicted wind speed values may be used for implementing intelligent wind turbine control, as illustrated below with respect to FIGS. 4 and 5.

While a limited number of embodiments are illustrated below, it will be understood that there are numerous modifications and variations therefrom.

As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

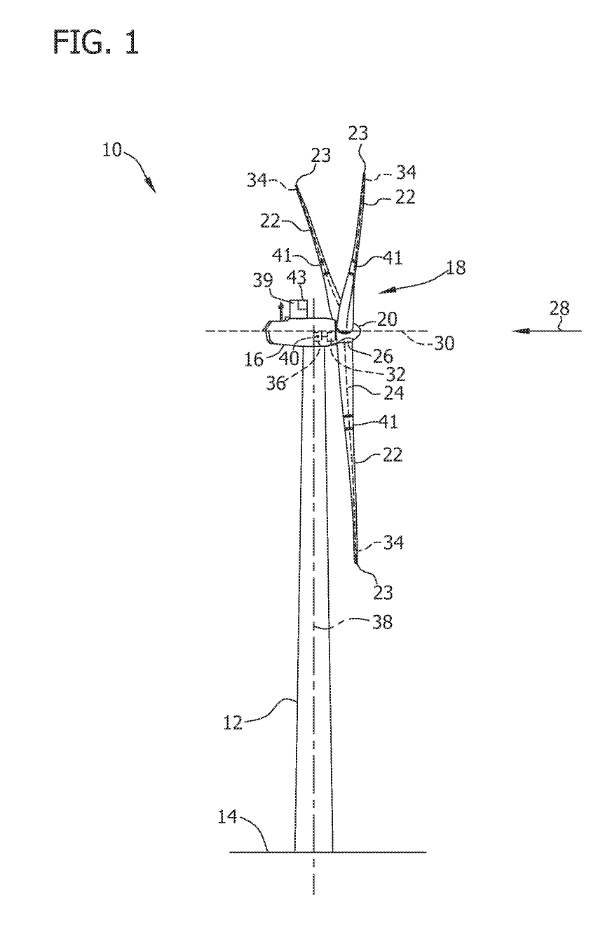

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor 18 includes a rotatable hub 20 and at least one rotor blade 22 coupled to and extending outward from hub 20. In the exemplary embodiment, rotor 18 has three rotor blades 22. In alternative embodiments, rotor 18 includes more or less than three rotor blades 22. Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Rotor blades 22 extend from blade root portions 34 to blade tips 25. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a manufactured length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m.

Rotor blades 22 may be aeroelastic tailored blades. The term “aeroelastic tailored blade” refers to a blade designed to effect, in operation, a coupling between (i) bending and/or extension, and (ii) twisting, such that, as it bends and extends due to the action of aerodynamic and inertial loads, the blade also twists so as to modify the blade's aerodynamic performance in a pre-determined manner. An aeroelastic tailored blade may include a composite lay-up structure (e.g., glass fiber-reinforced plastics) to create a coupling between the blade-twist and forces acting on the blade. In other examples, coupling between bending extension and twisting may be implemented using a swept blade, in which, due to the blade shape, thrust loading of the blade generates a torque relative to the blade center axis that causes blade-twist.

An aeroelastic tailored blade facilitates reducing loads acting on a wind turbine. However, since the aerodynamic characteristics of an aeroelastic tailored blade may significantly vary during operation, they may compromise wind turbine control. A controller implementing twist determination as described herein is convenient to compensate this variability of aeroelastic blades, since it provides blade-twist values that may be used by a turbine controller that takes into account blade-twist changes during operation of wind turbine 10. In particular, accurate values of the effective wind speed acting on aeroelastic blades may be inferred from the blade-twist values determined during operation. Using accurate values of the effective wind speed prevents that aeroelastic effects, including effects on aeroelastic instability, compromise wind turbine control.

As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position. Deflection of rotor blades 22 may cause a blade-twist that results in twist angle changes. Twist angle changes may be determined using a blade-twist module, illustrated below with respect to FIG. 5.

Actual blade-twist may be detected by monitoring the difference in perspective angle between two sections of rotor blades 22 along a longitudinal axis thereof. The root-to-tip twist is illustrated with respect to FIGS. 3A to 3B as an example of twist angle. FIG. 3 is a perspective view of rotor blade 22. FIG. 4 is another perspective view illustrating rotor blade 22 as seen from root portion 24.

In the shown perspectives, a trailing edge 302 of rotor blade 22 is disposed upwards. Root portion 24 defines a root plane 304 perpendicular to a center line 306 of blade 22 passing through root center 308. Root center 308 and tip point 310 define a blade tip axis 312. The offset from center line 306 and tip point 310 corresponds to an absolute bending 314. Absolute bending 314 may also be defined as the tip deviation from an idealized straight rotor blade. Center line 306 and blade tip axis 312 define a twist angle α corresponding to the root-to-tip twist.

The pitch angle or blade pitch of rotor blades 22, i.e., an angle that determines the angles of attack of sections of rotor blades 22, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

In the exemplary embodiment, control system 36 is shown as being centralized within nacelle 16, however, control system 36 may be a distributed system throughout wind turbine 10, on support system 14, within a wind farm, and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface, such as a mouse and a keyboard. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands. The execution of sequences of instructions is not limited to any specific combination of hardware circuitry and software instructions.

In at least some embodiments, wind turbine 10 includes a sensor arrangement 39 for measuring blade-twist values. As set forth below with respect to FIG. 5, sensor arrangement 39 may be communicatively coupled to elements of control system 36 to process signals of sensor arrangement 39 indicative of blade-twist values.

Sensor arrangement 39 may include a surveying system 43 to optically measure blade-twist angles. Thereby, the optical measurement may provide for a direct determination of blade-twist values. Such a surveying system may implement a camera system. In other examples, surveying system 43 may include an electronic distance measuring device implementing laser distance sensors or any other suitable distance sensor for measuring relative distances between blade sections. Fiducials (not shown) may be disposed along blades 22 for facilitating such a direct measurement.

Alternatively or in addition to a surveying system, sensor arrangement 39 may include strain gauges 41 operatively coupled to blades 22 to measure blade-twist values during operation of wind turbine 10. For example, a strain gauge may be arranged to measure torsional moments acting on root portion 24. Blade-twist values may be derived from the torsional moments using, for example, an appropriate modeling of blades 22 or look-up tables derived for associating torsional moment at blade root 24 with blade-twist. The look-up tables may be derived empirically either by experimentation or by simulation of the aerodynamic behavior of blades 22.

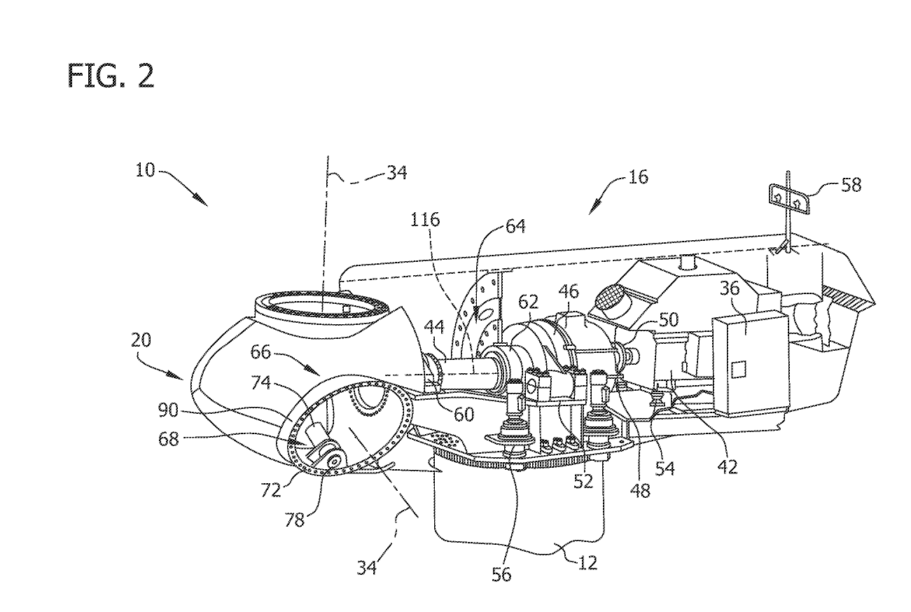

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50.

Nacelle 16 also includes a yaw drive mechanism 56 that may be used to rotate nacelle 16 and hub 20 on yaw axis 38 (shown in FIG. 1) to control the perspective of rotor blades 22 with respect to direction 28 of the wind. Nacelle 16 also includes at least one meteorological mast 58 that includes a wind vane and anemometer (neither shown in FIG. 2). Mast 58 provides information to control system 36 that may include wind direction and/or wind speed. As set forth above, an anemometer may, under certain circumstances (e.g., a turbulent wind regime), not be sufficient for accurately determining the wind speed acting on rotor 18.

In the exemplary embodiment, nacelle 16 also includes a main forward support bearing 60 and a main aft support bearing 62. Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and aft support bearing 62, are sometimes referred to as a drive train 64.

In the exemplary embodiment, hub 20 includes a pitch assembly 66. Pitch assembly 66 includes one or more pitch drive systems 68. Each pitch drive system 68 is coupled to a respective rotor blade 22 (shown in FIG. 1) for modulating the blade pitch of associated rotor blade 22 along pitch axis 34. Only one of three pitch drive systems 68 is shown in FIG. 2.

In the exemplary embodiment, pitch assembly 66 includes at least one pitch bearing 72 coupled to hub 20 and to respective rotor blade 22 (shown in FIG. 1) for rotating respective rotor blade 22 about pitch axis 34. Pitch drive system 68 includes a pitch drive motor 74, pitch drive gearbox 76, and pitch drive pinion 78. Pitch drive motor 74 is coupled to pitch drive gearbox 76 such that pitch drive motor 74 imparts mechanical force to pitch drive gearbox 76. Pitch drive gearbox 76 is coupled to pitch drive pinion 78 such that pitch drive pinion 78 is rotated by pitch drive gearbox 76. Pitch bearing 72 is coupled to pitch drive pinion 78 such that the rotation of pitch drive pinion 78 causes rotation of pitch bearing 72. More specifically, in the exemplary embodiment, pitch drive pinion 78 is coupled to pitch bearing 72 such that rotation of pitch drive gearbox 76 rotates pitch bearing 72 and rotor blade 22 about pitch axis 34 to change the blade pitch of blade 22.

Pitch drive system 68 is coupled to control system 36 for adjusting the blade pitch of rotor blade 22 upon receipt of one or more signals from control system 36. In the exemplary embodiment, pitch drive motor 74 is any suitable motor driven by electrical power and/or a hydraulic system that enables pitch assembly 66 to function as described herein. Alternatively, pitch assembly 66 may include any suitable structure, configuration, arrangement, and/or components such as, but not limited to, hydraulic cylinders, springs, and/or servo-mechanisms. Moreover, pitch assembly 66 may be driven by any suitable means such as, but not limited to, hydraulic fluid, and/or mechanical power, such as, but not limited to, induced spring forces and/or electromagnetic forces. In certain embodiments, pitch drive motor 74 is driven by energy extracted from a rotational inertia of hub 20 and/or a stored energy source (not shown) that supplies energy to components of wind turbine 10.

FIG. 5 is a block diagram of a control system 36. In the exemplary embodiment, control system 36 is a real-time controller that includes any suitable processor-based or microprocessor-based system, such as a computer system, that includes microcontrollers, reduced instruction set circuits (RISC), application-specific integrated circuits (ASICs), logic circuits, and/or any other circuit or processor that is capable of executing the functions described herein. In one embodiment, controller 102 may be a microprocessor that includes read-only memory (ROM) and/or random access memory (RAM), such as, for example, a 32 bit microcomputer with 2 Mbit ROM, and 64 Kbit RAM. As used herein, the term “real-time” refers to outcomes occurring a substantially short period of time after a change in the inputs affect the outcome, with the time period being a design parameter that may be selected based on the importance of the outcome and/or the capability of the system processing the inputs to generate the outcome.

In the exemplary embodiment, control system 36 includes a plurality of modules and sub-modules for implementing a variety of functions for performing control of the wind turbine. In the exemplary embodiment, control system 36 includes a determination module 400 and a regulator module 406. Determination module 400 includes a wind determination sub-module 404 and, optionally, a twist determination sub-module 402. Control system 36 may include further modules and/or sub-modules for implementing further control functionalities for operating wind turbine 10. The modules and sub-modules represent generally any combination of hardware and programming configured to implement the functions described in the following with respect to the individual modules and sub-modules. Individually illustrated modules and sub-modules may be combined as a single module responsible for those functions. Further, functions illustrated for an individual module or sub-module may be distributed between sub-modules. Further, in the exemplary embodiments, the modules are illustrated as implemented in a single controller system. In alternative embodiments, the modules may be distributed in different control systems communicatively coupled to implement the control functionalities described below.

According to at least some embodiments, determination module 400 is configured to predict wind speed values using blade-twist values indicative of an actual blade-twist of a rotor blade. This function may be implemented in a standalone manner by wind determination sub-module 404. For example, wind determination sub-module 404 may implement an extended Kalman filter as further detailed below. The extended Kalman filter may process two unknown states, namely, a state related to twist-angle (or of a parameter related thereto) and a state related to wind speed. Wind determination sub-module 404 may estimate the unknown states by matching a predicted turbine behavior with a measured behavior using a suitable system model. Such a system model may include a turbine model and, optionally, a wind model. The wind model may be based on a random model or any other suitable model that facilitates obtaining an estimation of wind behavior.

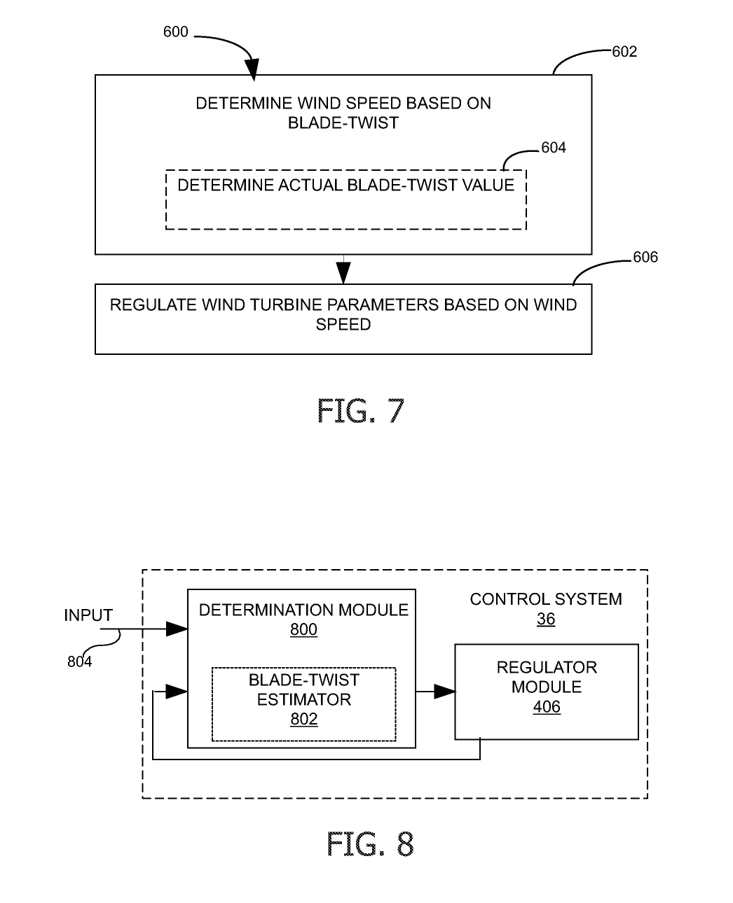

For the sake of illustration, FIG. 5 and the corresponding description below illustrates twist determination and wind determination as implemented in different independent sub-modules and/or performed in subsequent blocks (see FIG. 7). However, as illustrated in the previous paragraph, both determinations may be performed quasi-simultaneously, i.e., as part of a determination block in which both states are considered as unknown and are inferred from other parameters of wind turbine 10.

In the exemplary embodiment, determination module 400 may include, optionally, twist determination sub-module 402 to determine blade-twist values indicative of an actual blade-twist of a rotor blade during operation of the wind turbine.

According to some embodiments, twist determination sub-module 402 may be responsible for determining blade-twist values based upon measurements. More specifically, twist determination sub-module 402 may be operatively connected to sensors dedicated to measuring parameters of wind turbines directly related to blade-twist. In the exemplary block diagram, these embodiments are illustrated by the connection between determination module 400 and twist sensor arrangement 39. Through this connection, twist determination sub-module 402 may receive actual values of blade-twist provided by twist sensor arrangement 39. For example, twist sensor arrangement 39 provides actual values of blade-twist corresponding to strain gauge measurements from strain gauges 41. In other examples, twist sensor arrangement 39 provides actual values of blade-twist corresponding to relative positions measured by surveying system 43 on rotor blades.

In embodiments, twist determination sub-module 402 receives raw sensor values from twist sensor arrangement 39 and processes these sensors values to determine actual blade-twist values. In alternative embodiments, twist sensor arrangement 39 processes the raw sensor values and provides actual blade-twist values to twist determination sub-module 402. Values from different sensors may be combined for more accurately determining actual blade-twist values. In embodiments in which controller 36 implements wind speed determination sub-module 404 for determining wind speed values using a blade-twist value, wind speed determination sub-module 404 may perform the wind value determination by directly processing sensor values from twist sensor arrangement 39 or values directly correlated thereto.

According to some embodiments, twist determination sub-module 402 may be configured to determine blade-twist values based on an estimation inferred from actual values of parameters indirectly correlated to blade-twist such as, but not limited to, rotor rotation rate or blade pitch angle. Twist values may also be determined based on load measurements or measurements that are correlated to load (e.g., blade tip deflection or tower deflection). Such load measurements may be performed on the blade root, main shaft, or tower. More specifically, twist determination sub-module 402 may determine blade-twist values without using sensor measurements from a twist sensor arrangement but based on available values of other parameters of wind turbine 10. In such embodiments, as illustrated in the exemplary block diagram of FIG. 5, determination module 400 may be connected to arrangement 408 including sensors for measuring, during wind turbine operation, values of wind turbine parameters.

A blade-twist estimator may be used for determining blade-twist values based upon measured values of indirectly related wind turbine parameters. Such an estimator may be based on a wind turbine model. For example, twist determination sub-module 402 may be configured to determine blade-twist values based on an estimation inferred from a wind turbine model. More specifically, the estimator may use a simplified mathematical model of wind turbine 10 that associates blade-twist with some wind turbine parameters such as rotor speed and/or blade pitch angle as further detailed below. In some embodiments detailed further below, model based estimation may be implemented using an extended Kalman filter in which twist estimation and wind speed estimation are performed in the same process.

In other examples, the estimator may be based on look-up tables associating blade-twist with some wind turbine parameters such as rotor speed and/or blade pitch angle. The look-up tables may be derived empirically either by experimentation or by simulation of the aerodynamic behavior of blades 22 correlated to other wind turbine parameters. It will be understood that the particular design of a twist-blade estimator depends on the particular wind turbine design.

According to some embodiments, illustrated by FIG. 8, blade-twist estimation may be performed decoupled from wind speed determination. FIG. 8 is a block diagram of an alternative control system of wind turbine 10. In the alternative example, control system 36 includes a determination module 800 that implements a blade-twist estimator 802 to determine a blade-twist value indicative of an actual blade-twist of a rotor blade during operation of the wind turbine. Blade-twist estimator 802 is any specific combination of hardware circuitry and software instructions configured to determine a blade-twist value as described herein. The estimated blade-twist values are received and processed by regulator module 406 to operate wind turbine 10.

Referring back to FIG. 5, wind determination sub-module 404 is configured to determine wind speed values indicative of an effective wind speed using a blade-twist value. In the illustrated embodiment, twist determination sub-module 402 provides wind determination sub-module 404 with actual blade-twist values, which may be determined as illustrated above. Further, arrangement 408 (including sensors for measuring, during wind turbine operation, values of wind turbine parameters) may provide wind determination sub-module 404 with actual values of other wind turbine parameters such as, but not limited to, load torque, rotor speed or blade pitch angle.

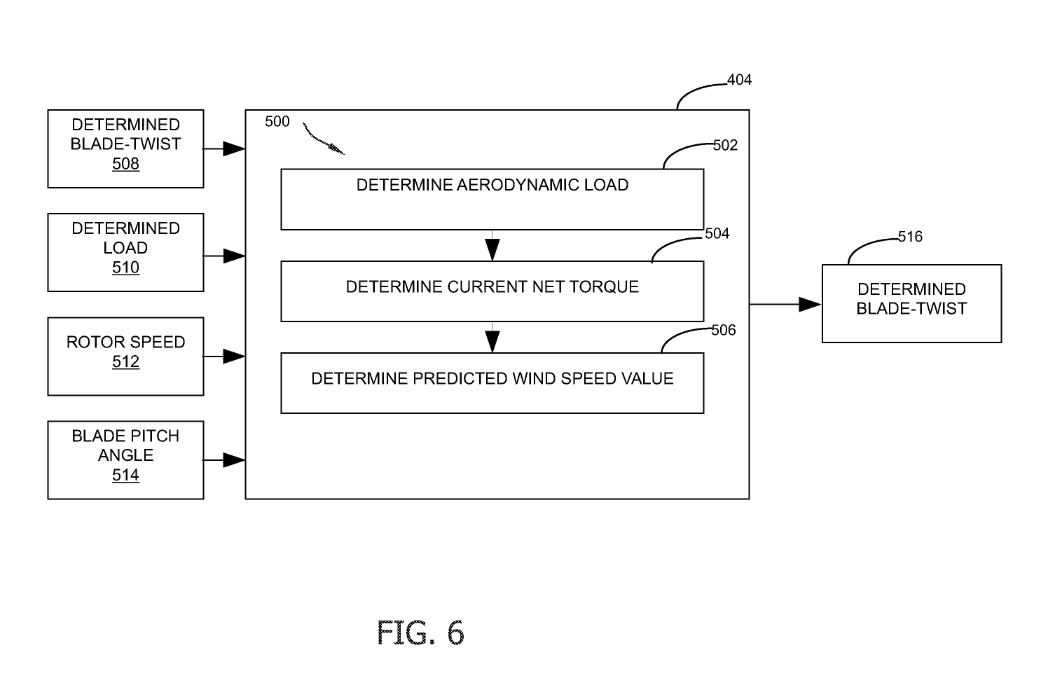

Wind determination sub-module 404 may implement a variety of methods for determining wind speed values. For example, the wind speed determination module may be configured to determine wind speed values using a pre-determined relationship associating wind speed with blade-twist. The pre-determined relationship takes into account the effect of the measured twist on the aerodynamic characteristic of the blade, as illustrated with respect to FIG. 6.

FIG. 6 is a block diagram schematically illustrating determination of wind speed values in control system 36. More specifically, the block diagram illustrates the structure and the method of operation of wind determination sub-module 404, wherein the determined wind speed values are predicted wind speed values. As further detailed below, the predicted wind speed values may be used by regulator module 406 to control operation of wind turbine 10.

The inputs of wind determination sub-module 404 include a determined blade-twist, which may be supplied by twist determination sub-module 402. The inputs may further include other wind turbine parameters such as load torque, rotor speed, or blade pitch angle. Measured values of load torque may be provided, for example, by electrical generator 42 or may be estimated from generator speed and generated power (speed*torque=power) taking into account conversion efficiency and loses in the electrical system. Other methods of determining load torque include utilizing electrical measurements at the generator 42 and combining the measurements with wind turbine models, such as field orientation modes or stator reference models. Measured values of rotor speed may be provided by a conventional sensor, such as an optical sensor implemented at rotor 18. Measured values of blade pitch angle may also be provided by conventional sensors, such as sonic linear position transducers at root portion 24.

Wind determination sub-module 404 may operate by, at every controller time tᵢ, predicting the values of wind speed at an ahead time Δt based on the current information available. As an example, wind speed values U(tᵢ+Δt) may be predicted using the following relationship:

U(tᵢ+Δt)=U(tᵢ)−K₁Tₙₑₜ(tᵢ)+K₂ε (eq. 1)

where U(tᵢ) corresponds to a current wind speed value that may have been previously determined by wind determination sub-module 404, Tₙₑₜ(tᵢ) is an estimate of the current net torque on the system that may be determined as further detailed below, ε(tᵢ) is a correction term that may be basically based on rotor speed error, and K₁, K₂ are constant gains that may be adjusted for providing dynamic stability in the operation of regulator module 406.

As set forth above with respect to equation 1, Tₙₑₜ(tᵢ) is an estimate of the current net torque on the system. It may be determined according to the following relationship:

Tₙₑₜ(tᵢ)=T_{wind}(tᵢ)T_{load}(tᵢ) (eq. 2)

where T_{wind}(tᵢ) corresponds to the aerodynamically driving torque and T_{load}(tᵢ) corresponds to the load torque illustrated above.

According to embodiments, the wind determination module may be configured to determine wind speed values based on an estimation inferred from a wind turbine model that considers an actual blade-twist. Such a wind turbine model is illustrated in the following. For example, the aerodynamically driving torque T_{wind}(tᵢ) may be considered as a function of aerodynamically varying quantities including blade-twist α and other parameters of wind turbine 10, such as the tip-speed ratio (ω/U, where ω corresponds to the rotor speed, and U corresponds to the wind speed) and blade pith angle ζ.The aerodynamically driving torque T_{wind}(tᵢ) may be determined according to the following relationship:

T_{wind}(tᵢ)=½dU²(tᵢ)F(α(tᵢ),ω(tᵢ)/U(tᵢ),ζ(tᵢ)) (eq. 3)

where d is the air density, and F(.) is an aerodynamic function that depends on twist-angle and, optionally, on other wind turbine parameters such as tip-speed ratio, and blade pitch angle.

In the exemplary embodiment, the values of function F(.) are actualized by wind determination sub-module 404 in every time cycle of controller 36. The actualized values of function F(.) do not only take into account changes in parameters, such as tip-speed ratio or blade pitch, but also change in blade-twist values. The changes in blade-twist values are determined by twist determination sub-module 402 and provided to wind speed determination sub-module 404. The particular form of function F(.) may be derived taken into account the particular geometry of rotor blades 22.

Function F(.) may be aerodynamically derived taking into account that it is dependent on blade size and shape and the aerodynamic power efficiency Cₚ. Blade shape may be based on an approximation so as to simplify calculations. Coefficient Cₚ may be computed using the Glauert blade element theory (see Eggleston and Stoddard, “Wind Turbine Engineering Design” (1987)). Values of function F(.) may be derived according to the following relationship:

F(α(tᵢ),ω(tᵢ)/U(tᵢ),ζ(tᵢ))=πR³(U(tᵢ)/Rω(tᵢ))Cₚ(α(tᵢ),ω(tᵢ)/U(tᵢ),ζ(tᵢ)), (eq. 4)

Function F(.) may be determined semi-empirically for a particular wind turbine design class by way of experimentation of simulation using a wind turbine module that associates blade-twist with changes into aerodynamic function F(.). The values of function F(.) may be stored as a pre-determined array associating blade-twist values (input values) to values of F(.) (output values). If function F(.) takes into account other wind turbine parameters as input, such as tip-to-speed ratio and/or blade pitch, a multi-dimensional array may be pre-determined for obtaining values of function F(.). Input values not included in the array may be determined by interpolation.

Referring back to FIG. 6, wind determination sub-module 404 may determine predicted wind speed values following procedure 500. At 502, wind determination sub-module 404 determines a current aerodynamically driving torque T_{wind}(tᵢ). This may be done, for example, by the wind determination sub-module 404 applying the following inputs into equation 3: blade twist 508 by twist determination sub-module 402, load torque 510, rotor speed 512, and blade pitch angle 514. At 504, wind determination sub-module 404 determines a current net torque Tₙₑₜ(tᵢ) by, for example, applying the depicted inputs and the current aerodynamically driving torque T_{wind}(tᵢ) determined at 502. At 506 wind determination sub-module 404 determines a predicted wind speed value 516 by, for example, applying the depicted inputs and the current net torque Tₙₑₜ(tᵢ) determined at 504.

The determination of wind speed values illustrated with respect to FIGS. 4 and 5 may be implemented using a wind speed estimator. More specifically, wind determination sub-module 404 may implement a wind speed estimator that includes at least an input for blade-twist; the estimator uses the blade-twist input for estimating wind speed. The blade-twist input may be provided by, for example, twist sensor arrangement 39. Alternatively, or in addition thereto, the estimator may derive blade-twist values from other wind turbine parameters, as further detailed above. The wind speed estimator may consider further inputs. For example, a wind speed estimator may use a blade-twist input, a rotor speed input, and a blade pitch angle for estimating wind speed acting on rotor 18. The rotor speed input and the blade pitch angle may be provided by turbine sensor arrangement 408.

Control system 36 may use the output values from the wind speed estimator to control wind turbine 10. More specifically, control system 36 may change pitch angle, or other wind turbine operational parameters, to change rotor speed based upon the wind speed estimation following a similar schema as illustrated in FIG. 5 and further detailed below.

A wind speed estimator may include a state estimator (also known as state observer) based on a mathematical model. A state estimator refers to a system that models wind turbine 10 in order to provide an estimate of a wind turbine internal state (more specifically, twist-angle and/or wind speed) using sensed measurements of inputs and outputs of wind turbine 10 (e.g., pitch angle, rotor speed or other parameters depicted in FIG. 6).

The wind speed estimator may be based on a simplified model of the wind turbine. Basically, the wind turbine model is a description of the wind turbine dynamics. It will be understood that there is a variety of available wind turbine models. The specific constitution of the wind turbine model typically depends on the particular wind turbine to be operated. For example, a wind turbine model may correspond to a specific wind turbine design class. Further, a wind turbine model may be designed considering simplification of estimation and observable parameters of the wind turbine.

Generally, a wind turbine model is given by a set of equations for describing one or more of the following parameters: rotor speed rate, generator speed rate, or rotor-generator shaft angular windup, and wind speed. Some particular examples of wind turbine models that may be used for building a wind speed estimator are described in the international application with publication number WO 2007/010322, which is incorporated herein by reference to the extent in which this document is not inconsistent with the present disclosure and in particular those parts thereof describing wind turbine modeling and wind speed estimation. Wind-twist may be incorporated in the model as a parameter dependent on other wind turbine parameters. In some embodiments, the mathematical model for the wind speed estimator corresponds to the model illustrated above with respect to Eqs. 1-3.

Based on the wind turbine a state vector can be derived. Further, the wind estimator may be designed such that the state vector is observable and, therefore, can be used for turbine control. More specifically, the particular form of the model as well as the measurable parameters can be chosen such that the output of the estimator can be used for wind turbine control in terms of stability, robustness and accuracy.

A wind speed estimator may be based on an extended Kalman filter. For example, a state estimator may use the inputs illustrated in FIG. 6 observed over time, considering noise and other inaccuracies, to produce wind speed predictions as well as uncertainty estimations of the predicted wind speed values based on these observations. Further, a Kalman based estimator may compute a weighted average of the predicted wind speed values and at least some of the inputs in the state estimator, the most weight being given to values with the least uncertainty so as to mitigate inaccuracies in the estimation. Since wind is characterized by a stochastic nature, an estimator based on a Kalman filter facilitates a more accurate prediction of wind speed values. An estimator based on a Kalman filter is illustrated in the international application with publication number WO 2007/010322 that may be adapted to implement wind speed estimation as illustrated herein. The wind speed estimator may be based on other type of estimators such as H_{∞}, least squares, or pole-placement.

Referring back to FIG. 5, regulator module 406 is configured to control operation of wind turbine 10 based on predicted wind speed values. As illustrated in the block diagram, regulator module 406 is configured to receive predicted wind speed values (e.g., U(tᵢ+Δt)) from wind speed determination sub-module 404. Further, regulator module 406 may receive from arrangement 408 actual values of other wind turbine parameters such as, but not limited to, load torque, rotor speed or blade pitch angle. Based on these inputs and regulation rules, regulator module may generate commands for operation of wind turbine 10 such as, but not limited to, a blade pitch command to pitch drive system 68 and/or a generator torque command to electrical generator 42.

There is a variety of regulation rules that regulator module 406 may implement for generation of the operational commands. For example, regulator module may implement a parameter schedule. The schedule includes the desired operating characteristics for wind turbine 10. The parameter schedule generates desired values for the wind parameters to be operated. For example, for a particular control cycle, the parameter schedule may generate a desired load torque and a desired blade pitch angle. The parameter schedule associates actual values of wind speed predictions to values of the desired parameters. This association between wind speed and desired parameter values may be pre-selected for a particular design class of wind turbines. In particular, curves associating wind speed values and values of the desired parameter may be generated for a particular type of wind turbine so as to meet the design constraints of the wind turbine. A particular example of a parameter schedule using predicted wind speeds is described in U.S. Pat. No. 5,155,375, which is incorporated herein by reference to the extent in which this document is not inconsistent with the present disclosure, and in particular those parts thereof describing a parameter schedule based on wind speed.

In other exemplary embodiments, regulator module 406 may implement a feedback control system, such as a PI, PID feedback loop, with gain and command outputs that adapt to changes in wind flow by appropriately modulating blade pitch and load torque at generator 42. In other embodiments, regulator module may implement state space control based on a dynamic model of wind turbine 10.

FIG. 7 is a diagram depicting a process 600 for operation of wind turbine 10. At 602 wind speed may be determined based on a parameter related to blade-twist. More specifically, wind speed may be determined using blade-twist values indicative of an actual blade-twist of a rotor blade. Wind determination sub-module 404 may be responsible for implementing wind speed determination as illustrated above. Determining wind speed may include predicting wind speed values based on the blade-twist value as illustrated above with respect to FIGS. 4 and 5.

For implementing block 602, an actual value of blade-twist may be determined. More specifically, as illustrated in FIG. 7, block 602 may include an optional sub-block 604 in which an actual blade-twist value is determined. Twist determination sub-module 402 may be responsible for implementing blade-twist determination as illustrated above. For example, blade-twist values may be determined based upon a sensor measurement performed on rotor blades 22. Sensor arrangement 22 may provide the sensor measurement. In other examples, the blade-twist value may be determined based on an estimation inferred from a wind turbine model such as described above with respect to implementation of twist determination sub-module 402. The determined actual value of blade-twist may be used to infer values of wind speed as set forth above. Wind speed may be determined at block 602 using a blade-twist value, which may correspond to a value of the actual blade-twist angle or to values of parameters correlated thereto, such as raw output values from twist sensor arrangement 39 or estimation parameters correlated to the actual blade-twist angle. Further, according to some examples, block 602 may include predicting wind speed values by applying an extended Kalman filter that processes a state related to twist-angle (or of a parameter related thereto) and a state related to wind speed.

At 606, wind turbine parameters may be regulated based on the wind speed determined at block 604. Regulator sub-module 402 may be responsible for implementing wind turbine regulation as illustrated above. More specifically, generator torque and blade pitch may be regulated as illustrated with respect to FIG. 5.

Method 600 facilitates operation of wind turbine 10. More specifically, determining blade-twist values during operation of wind turbine 10 facilitates a better assessment of the aerodynamic behavior of the wind turbine. This assessment facilitates a more precise control of the wind turbine and may provide insights into the wind turbine condition. Method 600 may be applied in variable wind speed turbines such as, for example, wind turbines implementing a control system including pitch regulation such as control system 36. In other embodiments, method 600 may be adapted for a stall regulated wind turbine where blade-twist determination and wind speed determination may be used for assessing the condition of components of a wind turbine.

Exemplary embodiments of systems and methods for operating a wind turbine are described in detail above. Control strategies exemplified herein facilitate reducing the mechanical loading on the wind turbine components such as blades, drive train, and tower. Further, these control strategies, specifically using a twist determination module, may be combined with aeroelastic tailored blades to further reduce such loading. Moreover, a twist determination module prevents that aeroelastic effects compromise control of a wind turbine by providing a more accurate estimate of the wind acting on a blade. A twist determination module may also be used to monitor condition of rotor blades.

The systems and methods above are not limited to the specific embodiments described herein, but rather, components of the systems and/or steps of the methods may be utilized independently and separately from other components and/or steps described herein and are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allow for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A controller for a wind turbine, the wind turbine including at least one rotor blade, the controller comprising:
a) a twist determination module to determine a blade-twist value, wherein the blade-twist value is indicative of an actual blade-twist of a rotor blade during operation of the wind turbine; and,
b) a wind speed determination module to determine at least one wind speed value indicative of a wind speed using the blade-twist value.

2. The controller of claim 1, wherein the twist determination module is configured to determine blade-twist values based upon sensor measurements for measuring blade-twist.

3. The controller of claim 1, wherein the twist determination module is configured to determine blade-twist values based on a blade-twist estimation.

4. The controller of claim 1, wherein the twist determination module is to infer the blade-twist estimation from a system model including, at least, a wind turbine model.

5. The controller of claim 1, wherein the twist determination module is configured to determine blade-twist values based on an extended Kalman filter.

6. The controller of claim 1, further being configured to be communicatively coupled to a sensor arrangement for measuring the actual blade-twist.

7. The controller of claim 1, wherein the determined wind speed values correspond to predicted wind speed values.

8. The controller of claim 7, further comprising a regulator module to control the operation of the wind turbine based on the predicted wind speed values.

9. A wind turbine comprising:
a) a tower;
b) a nacelle coupled to said tower;
c) a rotor rotatably coupled to said nacelle;
d) at least one blade coupled to said rotor and configured to rotate about a pitch axis; and,
e) a controller to operate the wind turbine based on predicted wind speed values, the controller including a determination module to predict wind speed values by estimating a blade-twist value indicative of an actual blade-twist of a rotor blade.

10. The wind turbine of claim 9, the determination module is configured to predict wind speed values by applying an extended Kalman filter that is adapted to process a first state related to a twist-angle and a second state related to a wind speed.

11. The wind turbine of claim 9, the determination module being further configured to determine an actual blade-twist value based on the estimated blade-twist value.

12. The wind turbine of claim 9, further comprising a sensor arrangement for measuring blade-twist, the sensor arrangement being communicatively coupled to the determination module.

13. The wind turbine of claim 9, wherein the sensor arrangement includes a surveying system configured to optically measure blade-twist values.

14. The wind turbine of claim 9, wherein the sensor arrangement includes a strain gauge arrangement operatively coupled to the at least one blade to measure blade torque.

15. The wind turbine of claim 14, wherein the determination module is configured to determine a blade-twist value based on a blade torque measurement using an output from the strain gauge arrangement.

16. The wind turbine of claim 9, wherein the at least one blade is an aeroelastic tailored blade.

17. A method of operating a wind turbine, wherein the wind turbine includes
a) a rotatable rotor; and,
b) at least one blade coupled to said rotor, the at least one blade being configured to rotate about a pitch axis,
the method comprising:
i) determining, during operation of the wind turbine, a wind speed based on an actual blade-twist of a rotor blade during operation of the wind turbine; and,
ii) controlling operation of said wind turbine using the determined wind speed.

18. The method of claim 17, wherein determining wind speed includes predicting a wind speed value based on a blade-twist value.

19. The method of claim 17, further comprising determining a blade-twist value based upon a sensor measurement performed on the at least one rotor blade.

20. The method of claim 17, further comprising determining a blade-twist value based on an estimation inferred from a system model, including, at least, a wind turbine model.
